(19) United States
(12) Patent Application Publication
(10) Pub. No.: US 2018/0343807 A1
(43) Pub. Date: Dec. 6, 2018

(54) "Method For Plant Propagation"

(71) Applicant: ForemostCo. Inc., Miami, FL (US)

(72) Inventor: Andrew J. Britten, Homestead, FL (US)

(21) Appl. No.: 15/612,622

(22) Filed: Jun. 2, 2017

(51) Int. Cl. A01G 1/00; A01G 9/10

(52) U.S. Cl. CPC A01G 1/001; A01G 9/1086; A01G 9/1026

(57) ABSTRACT

Provided herein are methods of propagating a plant, in particular a Heliconia. Also provided herein are products produced by such a method.

### BACKGROUND OF THE INVENTION

### Field of the Invention

The present invention relates to methods of propagating plants.

More particularly, the present invention relates to methods for propagating plants of the genus Heliconia and propagation products produced from such methods. Further, the present invention can extend to methods for propagating plants that fall outside of the Heliconia genus and producing plant products from the same.

### Description of Related Art

The genus Heliconia includes various species of flowering plants, including those referred to as “lobster claws.” These plants are tropical, being indigenous to Central and South America. The plants are popular in the United States, though propagation occurs in tropical regions in which the plant thrives. Propagation and shipping to the United States is thus required for sales in this country, but relevant regulations promulgated by the U.S. Department of Agriculture limit the importation of, inter alia, soil and other media that can carry invasive pests. This limits how many plants, including Heliconia, can be propagated and imported into this country.

The typical method that is currently practiced is to grow Heliconia plants in ground beds in a tropical area. As the plants start to send up new “suckers”, these suckers are dug up and cut from the mother plant to ship to the final customer. The suckers then need to be rooted at the customer level before it can be transplanted to its final pot to be grown out to maturity. From there, the transplanted Heliconia needs to grow an individual stalk and flower to then start initiation of side shoots and produce a full, attractive, commercially viable product.

There are substantial shortcomings with the existing methods, particularly the significant amount of time needed to grow the transplanted Heliconia from sucker, to individual stalk and flower, to full plant with side shoots. Because of this time, and unfavorable growth climates in the United States, particularly the northern states, it can be difficult to provide adequate supplies of Heliconia. Accordingly, the need exists in the art for improved methods of propagating Heliconia.

### SUMMARY OF THE INVENTION

Accordingly, provided herein are methods of propagating a plant including the steps of planting at least a portion of a plant in growth medium, growing the portion of the plant until a shoot forms, pruning the portion of the plant, growing the portion of the plant and shoot until a plurality of shoots have formed, dividing the pruned plant from the shoots, and replanting one or more of the shoots, each shoot being replanted in separate growth media. In some aspects, the plant is a Heliconia. In some aspects the plant is planted in a pot. In certain aspects, the pot has a diameter of between about 4 inches and about 6 inches. In further aspects, the pot has a diameter of about 4 inches.

In aspects, the portion of the plant and shoot are grown until at least four shoots are formed.

In aspects, the step of pruning the portion of the plant includes removing a growth tip of the portion of the plant.

Also provided herein are methods of preparing a commercial Heliconia product including the steps of planting at least a portion of a Heliconia plant in a growing medium, growing the portion of the plant until a shoot forms, pruning the portion of the plant, growing the portion of the plant and shoot until a plurality of shoots have formed, removing the plurality of shoots from the growing medium as a clump, removing media from roots of the clump, and wrapping the roots of the clump in a substrate. In some aspects, the plant is a Heliconia. In some aspects the plant is planted in a pot. In certain aspects, the pot has a diameter of between about 4 inches and about 6 inches. In further aspects, the pot has a diameter of about 4 inches.

In aspects, the portion of the plant and shoot are grown until at least four shoots are formed.

In aspects, the step of pruning the portion of the plant includes removing a growth tip of the portion of the plant.

In aspects, the substrate is coconut fiber. In further aspects, the coconut fibers are moistened with a liquid. In particular aspects, the liquid is water.

In some aspects, one or more nutrients are added to the growing medium. In some further aspects, the growing medium is soil.

In some aspects, the method of producing a commercial Heliconia product further includes the step of replanting the clump in growing medium. In further aspects, the growing medium is soil.

Also provided herein are products formed by the above methods.

Also provided herein are horticultural products including a plurality of rooted shoots or bibs of Heliconia and a substrate surrounding the roots of the shoots or bibs. In some aspects, the substrate is coconut fiber. In further aspects, the coconut fiber is moistened. In some aspects, the roots and substrate are received within a container. In some further aspects, the substrate maintains a pH of from about 5.5 to about 6.5.

### BRIEF DESCRIPTION OF THE DRAWINGS

FIG. 1 shows a flowchart of a method, according to one aspect of the invention described herein.

FIG. 2 shows planting a Heliconia bib, according to one aspect of the invention described herein.

FIG. 3 shows development of shoots, according to one aspect of the invention described herein.

FIG. 4 shows a Heliconia with fully developed shoots, according to one aspect of the invention described herein.

FIG. 5 shows division of a Heliconia clump for replanting, according to one aspect of the invention described herein.

FIG. 6 shows replanting of a divided clump of FIG. 5, according to one aspect of the invention described herein.

FIG. 7 shows a Heliconia clump with growth medium removed from the roots and packaged in a container, according to one aspect of the present invention.

FIG. 8 shows a plurality of Heliconia clumps with growth medium removed from the roots and packaged in containers, the plurality of clumps prepared for shipping, according to one aspect of the present invention.

### DESCRIPTION OF THE INVENTION

The following description is merely exemplary in nature and is in no way intended to limit the invention, its application, or uses. While the description is designed to permit one of ordinary skill in the art to make and use the invention, and specific examples are provided to that end, they should in no way be considered limiting. It will be apparent to one of ordinary skill in the art that various modifications to the following will fall within the scope of the appended claims. The present invention should not be considered limited to the presently disclosed aspects, whether provided in the examples or elsewhere herein.

The use of numerical values in the various ranges specified in this application, unless expressly indicated otherwise, are stated as approximations as though the minimum and maximum values within the stated ranges are both preceded by the word “about”. In this manner, slight variations above and below the stated ranges can be used to achieve substantially the same results as values within the ranges. Also, unless indicated otherwise, the disclosure of ranges is intended as a continuous range including every value between the minimum and maximum values. As used herein “a” and “an” refer to one or more.

As used herein, the term “Heliconia” means plants of the genus Heliconia, including, without limitation, hybrids of Heliconia, and offspring of crosses including Heliconia and successive filial generations thereof.

As used herein, the term “sucker” means a plant growing not from a seed, but from a meristem of the root at the base or at a certain distance from a plant, tree, or shrub.

As used herein, the term “bib” means an individual plant with a growing rhizome.

As used herein, the term “growth medium” means any substrate suitable for the growth of a plant of interest. Growth medium can include, without limitation, soil; soilless mixes such as one or more of sphagnum peat moss, perlite, vermiculite, and combinations thereof; sharp sand, compost, and fine bark or wood mulch.

Provided herein are methods of propagating plants. While plants of the genus Heliconia are exemplified, it should be apparent to one of ordinary skill in the art that the methods are broadly applicable, in particular, to plants of tropical origin, where propagation and transportation to more extreme climates are desired.

For example, and without limitation, suitable plants for the methods described herein include those in the genus Agapanthus, including at least Agapanthus africanus Agapanthus campanulatus, Agapanthus caulescens, Agapanthus coddii, Agapanthus inapertus, Agapanthus praecox, and Agapanthus walshii; those in the genus Anthurium including at least Anthurium belolonchium, Anthurium calomystrium, Anthurium cardiolochium, Anthurium chamaerepium, Anthurium cordaropunctatum, Anthurium dactylophyllium, Anthurium decurrentia, Anthurium digitnervium, Anthurium gymnopodium, Anthurium leptanthurium, Anthurium polyneurium, Anthurium porphyrochitonium, Anthurium schizoplacium, Anthurium semaeophyllium, Anthurium tetraspermium, Anthurium urospadix, and Anthurium xialophyllium.

Suitable plants for the methods described herein also include those in the genus Arum including at least Arum alpinariae, Arum apulum, Arum balansanum, Arum besserianum, Arum Byzantium, Arum concinnatum, Arum creticum, Arum cylindraceum, Arum cyrenaicum, Arum dioscoridis, Arum elongatum, Arum euxinum, Arum gratum, Arum hainesii, Arum hygrophilum, Arum idaeum, Arum italicum, Arum jacquemontii, Arum korolkowii, Arum lucanum, Arum maculatum, Arum megobrebi, Arum nigrum, Arum orientate, Arum palaestinum, Arum pictum, Arum polyphyllum, Arum purpureospathum, Arum rupicola, Arum sintenisii, and Arum×sooi.

Suitable plants for the methods described herein also include those in the genus Crinum including at least Crinum americanum, Crinum asiaticum, Crinum bulbispermum, Crinum latifolium, Crinum macowanii, Crinum moorei, Crinum pedunculatum, Crinum thaianum, and Crinum viviparum.

Suitable plants for the methods described herein also include those in the genus Dianella, including at least Dianella Dianella acutifolia, Dianella adenanthera, Dianella amoena, Dianella atraxis, Dianella bambusifolia, Dianella boliviana, Dianella brevicaulis (Ostenf.), Dianella brevipedunculata, Dianella caerulea, Dianella callicarpa, Dianella carolinensis, Dianella congesta, Dianella crinoides, Dianella daenikeri, Dianella dentate, Dianella ensifolia (L.) DC. (syn. D. ensata), Dianella fruticans, Dianella haematica, Dianella incollata, Dianella intermedia, Dianella javanica, Dianella latissimi, Dianella longifolia, Dianella monophylla, Dianella nervosa, Dianella nigra, Dianella odorata, Dianella pavopennacea, Dianella pendula, Dianella plicata, Dianella porracea, Dianella prunina, Dianella rara, Dianella revolute, Dianella saffordiana, Dianella sandwicensis, Dianella serrulata, Dianella stipitata, Dianella tarda, Dianella tasmanica, and Dianella tenuissima.

Suitable plants for the methods described herein also include those in the genus Dieffenbachia including at least Dieffenbachia aglaonematifolia, Dieffenbachia antioquensis, Dieffenbachia aurantiaca, Dieffenbachia beachiana, Dieffenbachia bowmannii, Dieffenbachia brittonii, Dieffenbachia burger, Dieffenbachia cannifolia, Dieffenbachia concinna, Dieffenbachia copensis, Dieffenbachia cordata, Dieffenbachia costata, Dieffenbachia crebripistillata, Dieffenbachia daguensis, Dieffenbachia davidsei, Dieffenbachia duidae (Steyerm.), Dieffenbachia elegans, Dieffenbachia enderi, Dieffenbachia fortunensis, Dieffenbachia fosteri, Dieffenbachia fournieri, Dieffenbachia galdamesiae, Dieffenbachia gracilis, Dieffenbachia grayumiana, Dieffenbachia hammelii, Dieffenbachia herthae, Dieffenbachia horichii, Dieffenbachia humilis, Dieffenbachia imperialis, Dieffenbachia isthmia, Dieffenbachia killipii, Dieffenbachia lancifolia, Dieffenbachia leopoldii, Dieffenbachia longispatha, Dieffenbachia lutheri, Dieffenbachia macrophylla, Dieffenbachia meleagris, Dieffenbachia nitidipetiolata, Dieffenbachia obliqua, Dieffenbachia obscurinervia, Dieffenbachia oerstedii, Dieffenbachia olbia, Dieffenbachia paludicola, Dieffenbachia panamensis, Dieffenbachia parlatorei, Dieffenbachia parvifolia, Dieffenbachia pittieri, Dieffenbachia seguine, Dieffenbachia shuttleworthiana, Dieffenbachia standleyi, Dieffenbachia tonduzii, Dieffenbachia weberbaueri, Dieffenbachia weirii, Dieffenbachia wendlandii, Dieffenbachia williamsii, and Dieffenbachia wurdackii.

Suitable plants for the methods described herein also include those in the genus Hosta including at least Hosta albofarinosa, Hosta×alismifolia, Hosta capitate, Hosta clausa, Hosta gracillima, Hosta hypoleuca, Hosta jonesii, Hosta kikutii, Hosta kiyosumiensis, Hosta longipes, Hosta longissimi, Hosta minor, Hosta plantaginea, Hosta pulchella, Hosta pycnophylla, Hosta rectifolia, Hosta rupifraga, Hosta shikokiana, Hosta sieboldiana, Hosta sieboldii, Hosta tsushimensis, Hosta ventricosa, Hosta venusta, and Hosta yingeri.

Suitable plants for the methods described herein also include those in the genus Liriope including at least Liriope graminifolia, Liriope kansuensis, Liriope longipedicellata, Liriope minor, Liriope muscari, and Liriope spicata.

Suitable plants for the methods described herein also include those in the family Marantaceae including at least those species categorized in the genera Afrocalathea, Calathea, Cominsia, Ctenanthe, Donax, Halopegia, Haumania, Hylaeanthe, Hypselodelphys, Indianthus, Ischnosiphon, Koernickanthe, Maranta, Marantochloa, Megaphrynium, Monophrynium, Monophyllanthe, Monotagma, Myrosma, Phacelophrynium, Phrynium, Pleiostachya, Sanblasia, Saranthe, Sarcophrynium, Schumannianthus, Stachyphrynium, Stromanthe, Thalia, Thaumatococcus, and Trachyphrynium.

Suitable plants for the methods described herein also include those in the family Musaceae including at least those species categorized in the genera Ensete, Musa, and Musella.

Suitable plants for the methods described herein also include those in the genus Ophiopogon including at least Ophiopogon acerobracteatus, Ophiopogon albimarginatus, Ophiopogon amblyphyllus, Ophiopogon angustifoliatus, Ophiopogon bockianus, Ophiopogon bodinieri, Ophiopogon brevipes, Ophiopogon caulescens, Ophiopogon chingii, Ophiopogon clarkei, Ophiopogon clavatus, Ophiopogon confertifolius, Ophiopogon cordylinoides, Ophiopogon corifolius, Ophiopogon dracaenoides, Ophiopogon filipes, Ophiopogon fooningensis, Ophiopogon grandis, Ophiopogon heterandrus, Ophiopogon hongjiangensis, Ophiopogon humilis, Ophiopogon intermedius, Ophiopogon jaburan, Ophiopogon japonicas, Ophiopogon jiangchengensis, Ophiopogon kradungensis, Ophiopogon latifolius, Ophiopogon leptophyllus, Ophiopogon longifolius, Ophiopogon lushuiensis, Ophiopogon mairei, Ophiopogon makolmsonii, Ophiopogon marmoratus, Ophiopogon megalanthus, Ophiopogon menglianensis, Ophiopogon micranthus, Ophiopogon motouensis, Ophiopogon multiflorus, Ophiopogon ogisui, Ophiopogon paniculatus, Ophiopogon peliosanthoides, Ophiopogon pierrei, Ophiopogon pingbienensis, Ophiopogon planiscapus, Ophiopogon platyphyllus, Ophiopogon pseudotonkinensis, Ophiopogon regnieri, Ophiopogon reptans, Ophiopogon reversus, Ophiopogon revolutus, Ophiopogon sar-garhwalensis, Ophiopogon sarmentosus, Ophiopogon siamensis, Ophiopogon sinensis, Ophiopogon sparsiflorus, Ophiopogon stenophyllus, Ophiopogon subverticillatus, Ophiopogon sylvicola, Ophiopogon szechuanensis, Ophiopogon tienensis, Ophiopogon tonkinensis, Ophiopogon tsaii, Ophiopogon umbraticola, Ophiopogon vietnamensis, Ophiopogon xylorrhizus, Ophiopogon yunnanensis, and Ophiopogon zingiberaceus.

Suitable plants for the methods described herein also include those in the genus Sansevieria including at least Sansevieria aethiopica, Sansevieria angustiflora, Sansevieria arborescens, Sansevieria aubrytiana, Sansevieria braunii, Sansevieria canaliculata, Sansevieria concinna, Sansevieria cylindrical, Sansevieria dawei, Sansevieria deserti, Sansevieria dooneri, Sansevieria ehrenbergii, Sansevieria eilensis, Sansevieria fasciata, Sansevieria gracilis, Sansevieria grandicuspis, Sansevieria grandis, Sansevieria grandis var. zuluensis, Sansevieria hyacinthoides, Sansevieria intermedia, Sansevieria kirkii, Sansevieria liberica, Sansevieria longiflora, Sansevieria metallica, Sansevieria parva, Sansevieria phillipsiae, Sansevieria pinguicula, Sansevieria raffillii, Sansevieria roxburghiana, Sansevieria senegambica, Sansevieria singularis, Sansevieria stuckyi, Sansevieria subspicata, Sansevieria suffruticosa, Sansevieria trifasciata, Sansevieria trifasciata var. laurentii, and Sansevieria zeylanica.

Suitable plants for the methods described herein also include those in the genus Zamioculcas including at least Zamioculcas zamiifolia.

Suitable plants for the methods described herein also include those in the family Zingiberaceae including at least those species in the genera Aulotandra, Siphonochilus, Tamijia, Aframomum, Alpinia, Amomum, Cyphostigma, Elettaria, Elettariopsis, Etlingera, Geocharis, Geostachys, Hornstedtia, Leptosolena, Paramomum, Plagiostachys, Renealmia, Siliquamomum (incertae sedis), Vanoverberghia, ×Alpingera, Burbidgea, Pleuranthodium, Riedelia, Siamanthus, Boesenbergia, Camptandra, Caulokaempferia (incertae sedis), Cautleya, Cornukaempferia, Curcuma, Curcumorpha, Distichochlamys, Haniffia, Haplochorema, Hedychium, Hitchenia, Kaempferia, Laosanthus, Nanochilus, Paracautleya, Parakaempferia, Pommereschea, Pyrgophyllum, Rhynchanthus, Roscoea, Scaphochlamys, Smithatris, Stadiochilus, Szahlianthus, Zingiber, Gagnepainia, Globba, and Hemiorchis.

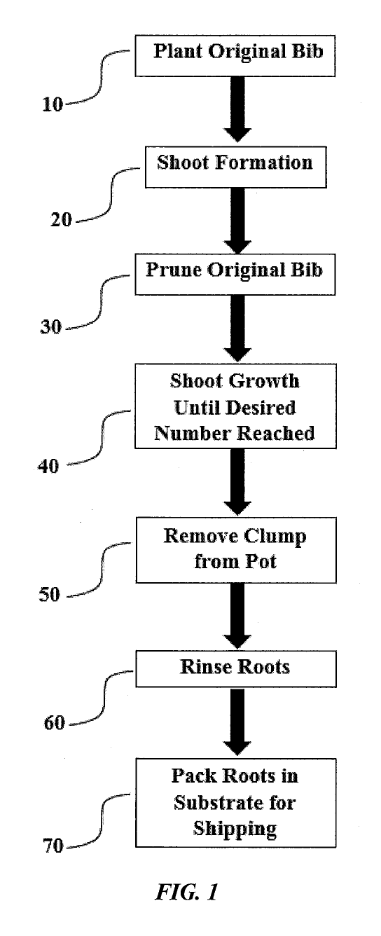

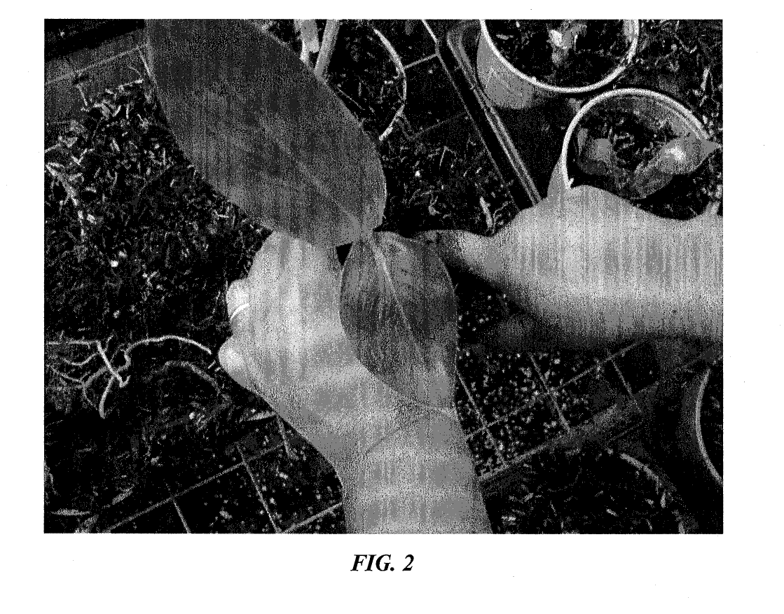

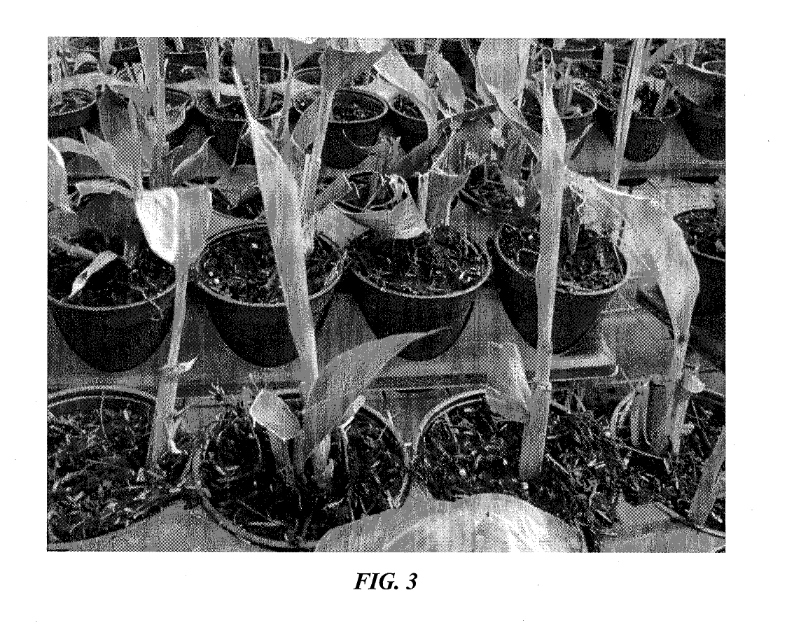

With reference to FIG. 1, the method includes the step of planting (10) and growing one or more Heliconia bibs in growth medium until one or more additional shoots appear(s) (20). A non-limiting example of planting a Heliconia bib is shown in FIG. 2. In aspects, the growth medium is soil. While those of ordinary skill in the art will appreciate that the growth media can be provided in any suitable pot or receptacle, in aspects, a pot having a diameter of 4 to 6 inches is used, as a smaller-diameter pot promotes branching and allows for precise control of growth. In a preferred aspect, the original bib is placed into a four inch diameter pot. In aspects, the original bib is grown from 2-8 weeks, in aspects from 4-6 weeks, all subranges therebetween inclusive, until one or more additional shoots(s) appear (20). A non-limiting example of shoot formation is shown in FIG. 3. Those of skill in the art will appreciate that environmental and growth media conditions can vary, and, thus, that time to shoot development can vary accordingly.

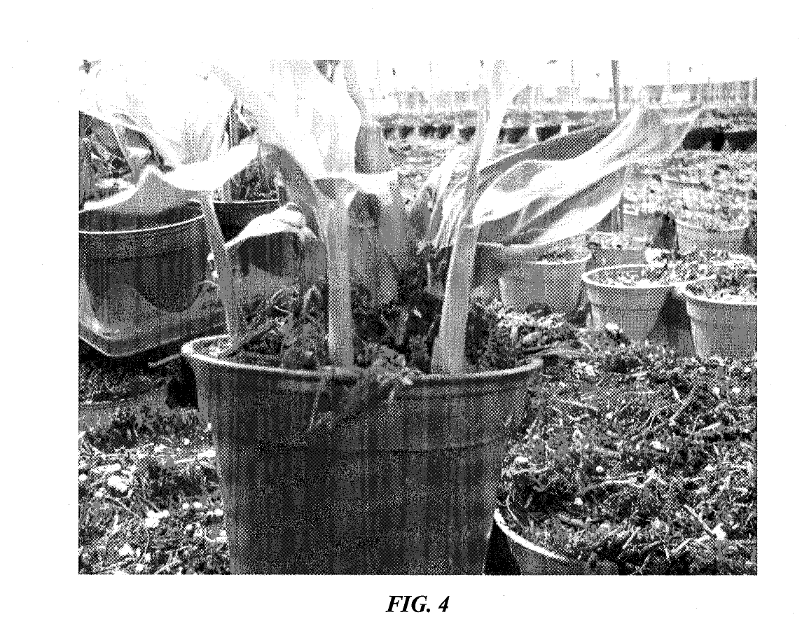

In accordance with the method described herein, when additional shoot(s) appear in the pot with the original bib (20), the original bib is pruned (30). In a preferred aspect, the original bib is pruned to eliminate only the growing tip of this original bib. This allows it to retain at least one leaf that helps in the food production for the growth of suckers, but renders the original bib non-viable for future production. The original bib and the nascent shoot(s) are then left in the pot until a desired number of shoots is reached (40). A non-limiting example of a pot with multiple Heliconia shoots is shown in FIG. 4. In a preferred aspect, the process is carried out until the original bib has produced at least four shoots. This process of generating four or more shoots can take from 6-12 weeks, in aspects from 8-10 weeks, all subranges therebetween inclusive, from planting of the original bib.

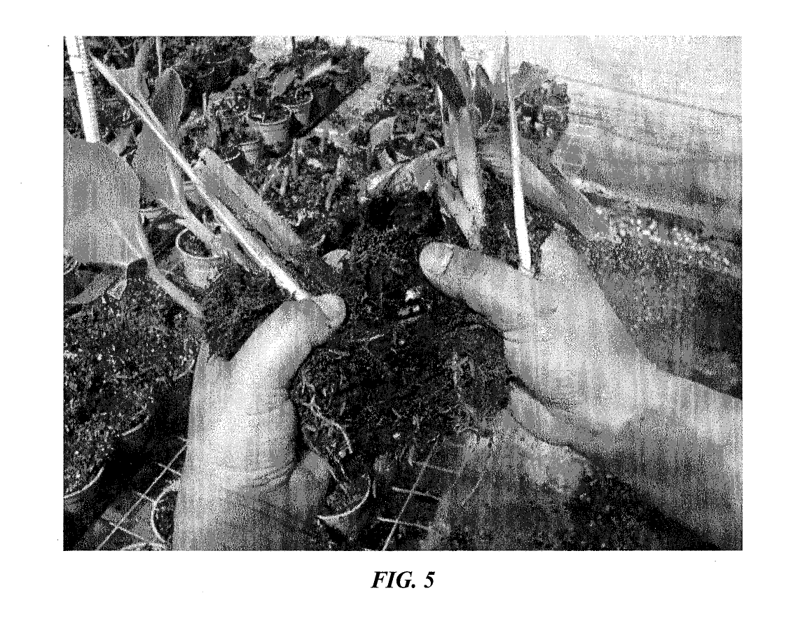

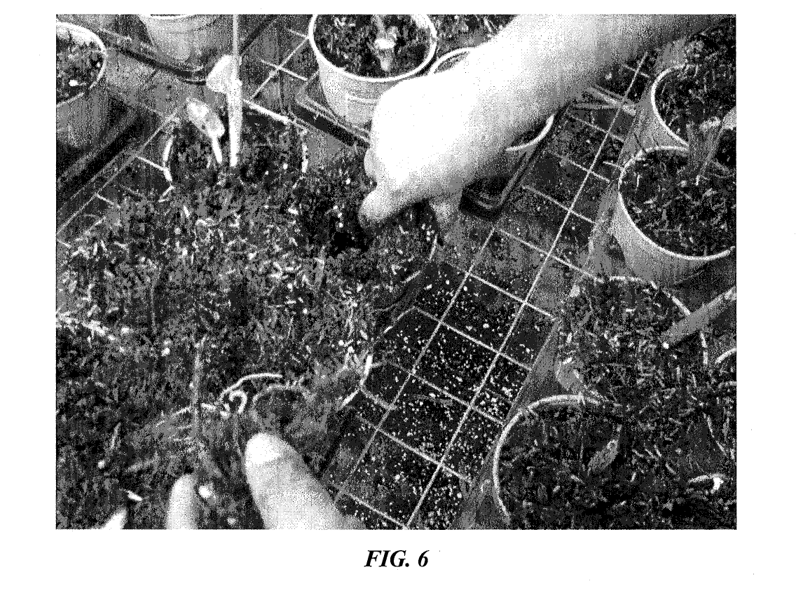

In aspects (not shown in FIG. 1), the method also includes the step of removing one or more shoots from the pot and dividing the shoots from one another, to provide a number, for example and without limitation, four individual shoots. A non-limiting example of such shoot division is shown in FIG. 5. In some aspects the shoots are then utilized as original bibs and placed into new pots to repeat the above process, as shown, for example and without limitation, in FIG. 6. The original bib that was pruned is also discarded.

With continuing reference to FIG. 1, in other aspects, when an original bib has produced a desired number of shoots, and those shoots have matured into bibs, for example and without limitation, four shoots/bibs, the grouping, called a clump, is removed from the pot (50) for transportation. The growth media is then removed from the clump (60) by washing the clump with a solvent, for example and without limitation, water. Removing the growth medium leaves a medium-free, rooted clump of Heliconia that is suitable for importation into the United States. The roots of the clump are then optionally wrapped or encased in a substrate (70) for protection during transportation. In some aspects, if a substrate is utilized, the substrate is foam or a foam-based product, newspaper, or gel. In a preferred aspect, the substrate is coconut fiber, and in a particulary preferred aspect, a ground coconut fiber medium. In another particularly preferred aspect, the coconut fiber is moistened with a liquid, for example and without limitation, water. While it is not desirable to include some types of nutrient additives in the liquid due to concerns of salinity/hypertonicity and possible detrimental effects on the health of the clump during shipment, in some aspects, one or more growth regulators/promotors is included during the process of growing the shoots from the original bib, such that the regulator/promotor is taken up into the clump prior to separation and shipment. Such growth regulators/promotors are known to those of ordinary skill in the art and include, without limitation, paclobutrazol, ancymidol, uniconazole, and chlomequat.

In aspects, the shoots/clump are grown with exposure to one or more nutrient additives suitable for maintaining the health of the clump, such as a fertilizer. In particular, with regard to Heliconia, suitable nutrient additives can include magnesium supplements, calcium supplements, nitrogen supplements, phosphorous supplements, potassium supplements, and iron supplements. In other aspects, the liquid provides a slightly acidic environment for the roots of the clump, for example, and without limitation, a pH of between about 5.5 and about 6.5, all subranges ranges therebetween inclusive. This pH range matches that which should be present in the growth medium during growth of the shoots in the pot, prior to removal, washing, and wrapping/encasing.

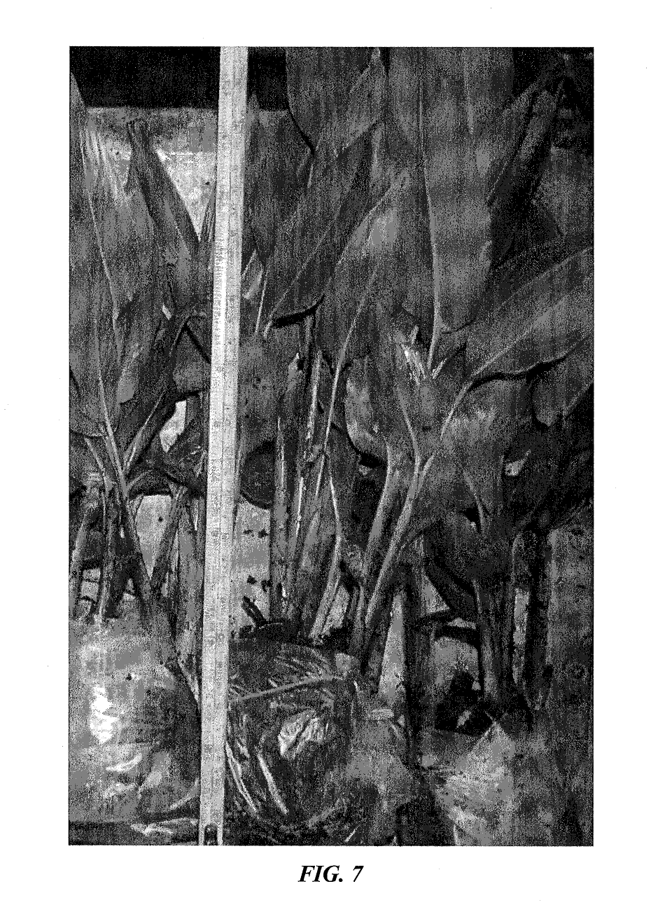

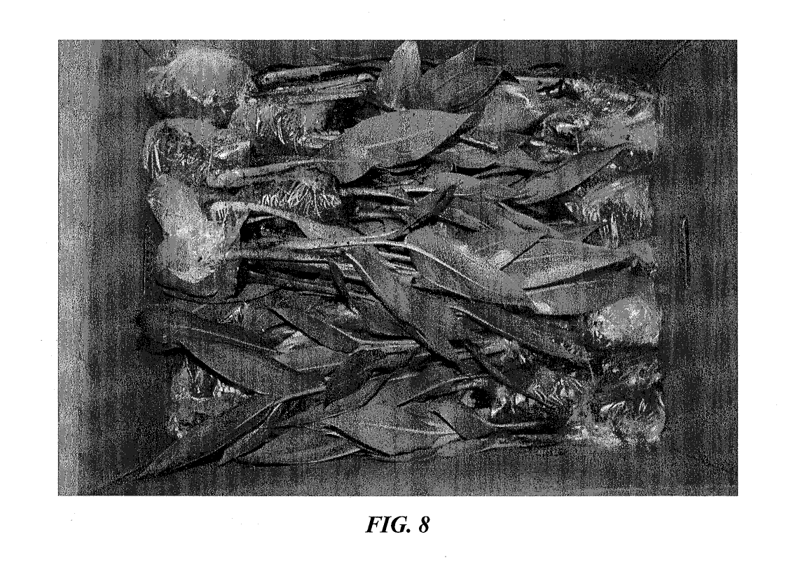

The wrapped or encased Heliconia roots can then be further wrapped or encased in, for example and without limitation, a container such as those made of plastic or other material suitable for shipment of living plant material. A non-limiting example of Heliconia clumps with roots enclosed in a container is shown in FIG. 7. A plurality of Heliconia clumps can then be packaged for transportation to a grower or other consumer for finishing. A non-limiting example of such shipment conditions is shown in FIG. 8. The consumer/grower can then finish the Heliconia in a commercial vessel.

Accordingly, also provided herein is a horticultural product including a plurality of rooted shoots or bibs of a plant such as, for example and without limitation, Heliconia. The roots of the rooted shoots/bibs are surrounded by, embedded in, or received within a substrate as described above. In some aspects, the substrate is coconut fiber. In a preferred aspect, the substrate is moistened coconut fiber. In additional aspects, the roots of the plurality of shoots and the substrate are further received within a container, as described above.

The methods described herein produce a commercial product that includes a Heliconia with multiple bibs having a root system wrapped or encased in a substrate. This commercial product is superior to those produced from prior methods of Heliconia propagation in that the commercial product will already include multiple bibs. This allows for a more efficient finishing and quicker production of flowers, allowing the sale of Heliconia in geographies where prior methods, which required substantial times to produce commercially-viable product, made availability impossible. Whereas prior methods could provide a flowering Heliconia in 17 weeks, methods as described herein allow for production of a commercially viable Heliconia product in as little as 12 weeks.

### Clauses

Clause 1: A method of propagating a plant, comprising the steps of: (a) planting at least a portion of pk a plant in a growth medium; (b) growing the portion of the plant until a shoot forms; (c) pruning the portion of the plant; (d) growing the portion of the plant and shoot until a plurality of shoots have formed; (e) dividing the pruned plant from the shoots; and (f) replanting one or more of the shoots, wherein each of the one or more shoots are replanted in separate growth media.

Clause 2: The method of clause 1, wherein the plant is a Heliconia.

Clause 3: The method of clause 1 or clause 2, wherein the portion of the plant is planted in a pot.

Clause 4: The method of clause 3, wherein the pot has a diameter of between about 4 inches and about 6 inches.

Clause 5: The method of clause 3, wherein the pot has a diameter of about 4 inches.

Clause 6: The method of any one of clauses 1-5, wherein in step (d), the portion of the plant and shoot are grown until at least four shoots are formed.

Clause 7: The method of any one of clauses 1-6, wherein step (c) comprises removing a growth tip of the portion of the plant.

Clause 8: A method of preparing a commercial horticultural product, comprising the steps of: (a) planting at least a portion of a plant in a growing medium; (b) growing the portion of the plant until a shoot forms; (c) pruning the portion of the plant; (d) growing the portion of the plant and shoot until a plurality of shoots have formed; (e) removing the plurality of shoots from the growing medium as a clump; (f) removing media from roots of the clump; and (g) wrapping the roots of the clump in a substrate.

Clause 9: The method of clause 8, wherein the plant is a Heliconia.

Clause 10: The method of clause 8 or clause 9, wherein the portion of the plant is planted in a pot.

Clause 11: The method of clause 10, wherein the pot has a diameter of between about 4 inches and about 6 inches.

Clause 12: The method of clause 10, wherein the pot has a diameter of about 4 inches.

Clause 13: The method of any one of clauses 8-12, wherein in step (d), the portion of the plant and shoot are grown until at least four shoots are formed.

Clause 14: The method of any one of clauses 8-13, wherein step (c) comprises removing a growth tip of the portion of the plant.

Clause 15: The method of any one of clauses 8-14, wherein the substrate is coconut fiber.

Clause 16: The method of clause 15, wherein the coconut fibers are moistened with a liquid.

Clause 17: The method of clause 16, wherein the liquid is water.

Clause 18: The method of any one of clauses 8-17, wherein one or more nutrients are added to the growing medium.

Clause 19: The method of any one of clauses 8-18, wherein the growing medium is soil.

Clause 20: The method of any one of clauses 8-19, further comprising the step of: (h) replanting the clump in growing medium.

Clause 21: The method of clause 20, wherein the growing medium is soil.

Clause 22: A product formed from the method according to any one of clauses 8-19.

Clause 23: A product formed from the method according to clause 20.

Clause 24: A horticultural product comprising: a plurality of rooted shoots or bibs of a plant; and a substrate surrounding the roots of the shoots or bibs.

Clause 25: The horticultural product of clause 24, wherein the plant is Heliconia.

Clause 26: The horticultural product of clause 24 or clause 25, wherein the substrate is coconut fiber.

Clause 27: The horticultural product of clause 26, wherein the coconut fiber is moistened.

Clause 28: The horticultural product of any one of clauses 24-27, wherein the roots and substrate are received within a container.

Clause 29: The horticultural product of any one of clauses 24-28, wherein the substrate maintains a pH of from about 5.5 to about 6.5.

While the present invention has been described in terms of the above examples and detailed description, those of ordinary skill will understand that alterations may be made within the spirit of the invention. Accordingly, the above should not be considered limiting, and the scope of the invention is defined by the appended claims.

The invention claimed is:

1. A method of propagating a plant, comprising the steps of:
(a) planting at least a portion of a plant in a growth medium;
(b) growing the portion of the plant until a shoot forms;
(c) pruning the portion of the plant;
(d) growing the portion of the plant and shoot until a plurality of shoots have formed;
(e) dividing the pruned plant from the shoots; and
(f) replanting one or more of the shoots, wherein each of the one or more shoots are replanted in separate growth media.

2. The method of claim 1, wherein the plant is a Heliconia.

3. The method of claim 1, wherein the portion of the plant is planted in a pot having a diameter of between about 4 inches and about 6 inches.

4. The method of claim 1, wherein in step (d), the portion of the plant and shoot are grown until at least four shoots are formed.

5. The method of claim 1, wherein step (c) comprises removing a growth tip of the portion of the plant.

6. A method of preparing a commercial Heliconia product, comprising the steps of:
(a) planting at least a portion of a plant in a growing medium;
(b) growing the portion of the plant until a shoot forms;
(c) pruning the portion of the plant;
(d) growing the portion of the plant and shoot until a plurality of shoots have formed;
(e) removing the plurality of shoots from the growing medium as a clump;
(f) removing media from roots of the clump; and
(g) wrapping the roots of the clump in a substrate.

7. The method of claim 6, wherein the portion of the plant is planted in a pot having a diameter of between about 4 inches and about 6 inches.

8. The method of claim 6, wherein in step (d), the portion of the plant and shoot are grown until at least four shoots are formed.

9. The method of claim 6, wherein step (c) comprises removing a growth tip of the portion of the plant.

10. The method of claim 6, wherein the substrate is coconut fiber.

11. The method of claim 10, wherein the coconut fibers are moistened with a liquid.

12. The method of claim 6, wherein one or more nutrients are added to the growing medium.

13. The method of claim 6, wherein the growing medium is soil.

14. The method of claim 6, further comprising the step of:
(h) replanting the clump in growing medium.

15. The method of claim 14, wherein the growing medium is soil.

16. A horticultural product comprising:
a plurality of rooted shoots or bibs of a Heliconia; and
a substrate surrounding the roots of the shoots or bibs.

17. The horticultural product of claim 16, wherein the substrate is coconut fiber.

18. The horticultural product of claim 17, wherein the coconut fiber is moistened.

19. The horticultural product of claim 16, wherein the roots and substrate are received within a container.

20. The horticultural product of claim 16, wherein the substrate maintains a pH of from about 5.5 to about 6.5.
